(19) United States
(12) Patent Application Publication
(10) Pub. No.: US 2010/0263885 A1
(43) Pub. Date: Oct. 21, 2010

(54) PROTECTION SYSTEMS AND METHODS FOR ELECTRONIC DEVICES

(75) Inventor: Phillip E. Tuma, Faribault, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/427,245

(22) Filed: Apr. 21, 2009

(51) Int. Cl. A62C 3/16; A62C 35/00

(52) U.S. Cl. 169/46; 169/16

(57) ABSTRACT

Protection systems and methods for heat-generating electronic devices are provided that include thermal management fluids that are fire extinguishing agents or can extinguish flames. The provided systems and methods include a recirculating thermal management fluid. The fluid circulates through a conduit that includes at least one valve. The valve can be opened in response to a stimulus, such as a flame or fire, diverting the fluid onto the heat-generating electronic device or onto a flame.

### FIELD

This disclosure relates to heat-generating electronic devices, such as datacenters, batteries and power converters, and systems and methods for cooling the devices with flame extinguishing coolants.

### BACKGROUND

In nearly every modern application of electronics, the dissipation of heat is an important consideration to designers. In portable and hand-held devices, for example, the desire to miniaturize while adding functionality increases the thermal power density making cooling the electronics and the batteries within them more challenging. As computational power increases within desktop computers, datacenters and telecommunications centers, so does the heat output. Power electronic devices such as the traction inverters in plug-in electric or hybrid vehicles, wind turbines, train engines, generators and various industrial processes make use of transistors that operate at ever higher currents and heat fluxes.

Accordingly, devices such as personal computers operate with fans that air cool the heat produced by components such as microprocessors, memory, power supply, etc. Telecommunication centers and datacenters, which are large networks of multiple electronic devices, make use of large distributed air conditioning systems that may constitute multiple fans, blowers, compressors and pumps that cool the air provided to the devices. Multiple heat transfer processes typically move the heat to outside air or groundwater. Power electronics devices often make use of large blowers applied to heat sinks attached to power electronics modules composed of semiconductor devices.

Use of liquid cooling is becoming increasingly popular for such devices. In many power electronic devices, the desired power density makes air cooling of the components within it impractical. In large data and telecommunications centers, liquid cooling is replacing air in many of the heat transfer processes in order to increase energy efficiency. Although water or water-based systems are sometimes used, dielectric heat transfer media are typically utilized because they do not conduct electricity in use or in the event of a leak. Often times the dielectric media are evaporated and condensed within a loop as they receive and give up heat. These media include, for example, perfluorocarbons (PFCs), including perfluoropolyethers (PFPEs), perfluoroamines (PFAs) and perfluoroethers (PFEs), hydrofluoroethers (HFEs), hydrofluorocarbons (HFCs), silicones and hydrocarbons.

In some electronic devices, the heat that is generated by the devices can reach a threshold at which the heat-generation becomes self-accelerated or in what is termed runaway. This can be a problem, for example, in devices like batteries or in devices that heat up when they fail. The excessive heat can damage the electronic devices or, in the event of fire or explosion, can spread to cause widespread damage and injuries. For high value devices such as business critical datacenters or emergency power converters, it is typical to have a secondary fire-extinguishing system that can extinguish flames if they are detected to protect personnel, information and expensive equipment. Such fire extinguishing systems often exist alongside a liquid cooling system and often make use of halogenated chemicals as extinguishing agents. One common agent, bromotrifluoromethane, is highly ozone-depleting and has been phased out of production by the Montreal Protocol. Non-ozone-depleting PFCs and HFCs can exhibit atmospheric lifetime values of up to 50,000 years resulting in high global warming potentials (“GWP”). GWP is the integrated potential warming due to the release of one (1) kilogram of sample compound relative to the warming due to one (1) kilogram of CO₂ over a specified integration time horizon.

### SUMMARY

It would be desirable to have a thermal management system that also provides fire protection. It would also be desirable to have a thermal management system that includes a fire extinguishing agent that does not damage electronic components. Additionally, it would be desirable to have a thermal management system that includes a coolant, fire extinguishing agent combination that has a low global warming potential.

In one aspect, a protection system is provided that includes a heat-generating electronic apparatus, a thermal management system that includes at least one recirculating thermal management fluid, the thermal management system designed so as to transfer heat from the heat-generating electronic apparatus, and a valve in the thermal management system designed to cause at least a part of the thermal management fluid to be diverted from the thermal management system through the valve and onto the heat-generating electronic apparatus or a flame nearby in response to a stimulus, wherein the thermal management fluid includes a fire extinguishing agent.

In another aspect, a method of thermal management and fire protection of an electronic apparatus is provided that includes providing an electronic apparatus, thermally managing the electronic apparatus with a thermal management system comprising at least one recirculating thermal management fluid, sensing a flame in or near the electronic apparatus, opening a valve in the thermal management system in response to sensing a flame in or near the electronic apparatus, diverting thermal management fluid from the thermal management system by the valve onto the electronic apparatus or a flame nearby, and extinguishing the flame, wherein the thermal management fluid includes a fire extinguishing agent.

In this disclosure:

“heat-generating electronic devices” refers to individual electronic apparati such as, for example, personal computers, hand-held phones, lithium ion batteries, etc., the components within these apparati such as, for example, IC chips, power transistors, etc., as well as systems that include many electronic apparati such as, for example, datacenters, telecommunication centers, etc.;

“heat-management fluid” and “heat-transfer fluid” and “heat-transfer medium” are used interchangeably herein and refer to fluids that can transfer heat from one location to another; and

“thermal contact” refers to the condition of having two elements that have different temperatures located in proximity to each other so that heat can flow from the warmer element to the colder element.

The provided protection system can provide heat transfer from heat-generating electronic devices using thermal management fluids. Additionally these systems can use fluids that have high heat-transfer capability but low environmental impact as far as global warming potential, ozone depletion capability, and inertness to sensitive electronic devices. The systems can also, in response to a stimulus, be diverted onto at least some of the electronic devices and can extinguish flames and can stop self-accelerated heat-generation. Thus, the fluids have dual functions-they function as heat-management fluids, but can also remove the need for separate, costly fire protection systems that are currently used for devices such as datacenters.

The above summary is not intended to describe each disclosed embodiment of every implementation of the present invention. The brief description of the drawing and the detailed description which follows more particularly exemplify illustrative embodiments.

### BRIEF DESCRIPTION OF THE DRAWINGS

FIG. 1 is a schematic drawing of an air-cooled datacenter layout.

FIG. 2 is a schematic drawing of a heat-transfer path in a typical air-cooled datacenter such as that depicted in FIG. 1.

FIG. 3 is an embodiment of the provided protection system for an electronic device.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

A protection system for electronic devices is herein described. The system can protect electronic devices from overheating and can, in response to a stimulus, direct a thermal management fluid that includes a fire extinguishing agent onto the electronic devices, to thereby extinguish any flame or fire that has resulted from overheating. The protection system includes a heat-generating electronic device. The heat-generating electronic devices can be any electronic device or system that includes an electronic element that typically generates heat. Exemplary heat-generating electronic elements include semiconductor integrated circuits (ICs), electrochemical cells, power transistors, resistors, and electroluminescent elements. The electronic devices can include, but are not limited to microprocessors, wafers used to manufacture semiconductor devices, power control semiconductors, electrochemical cells (including a lithium-ion cells), electrical distribution switch gear, power transformers, circuit boards, multi-chip modules, packaged or unpackaged semiconductor devices, semiconductor integrated circuits, fuel cells, lasers (conventional or laser diodes), light emitting diodes (LEDs), and electrochemical cells used for high power applications such as, for example, hybrid or electric vehicles. Other devices include personal computers, microprocessors, servers, cell phones, and personal digital assistants. Datacenters, which are a collection of computer systems and associated components, such as telecommunications and storage systems that generally include redundant or backup power, redundant data communications connections, environmental controls (including, for example, air conditioning and fire suppression), and security devices, are also within the scope of the provided protection systems.

The electronic device includes a thermal management system that includes at least one recirculating thermal management fluid. The thermal management fluid includes a fire extinguishing agent. The thermal management system is designed to transfer heat from the heat-generating electronic device to a condenser or heat exchanger. The thermal management system can recirculate the thermal management fluid passively or by using mechanical equipment such as, for example, a pump. Passive recirculating systems work by transferring heat from the electronic device to the thermal management fluid until it typically is vaporized, allowing the heated vapor to proceed to a condenser at which it can transfer its heat to the condenser surface and condense back into a liquid, and then allowing the condensed liquid to reflow into the thermal management fluid in contact with the electronic device. Exemplary passive thermal management systems for electrochemical cells are described, for example, in U.S. Ser. No. 11/969,491 (Jiang et al.). Passive thermal management systems can include, for example, single phase or two-phase immersion cooling. In other embodiments, thermal management systems can include pumped two-phase systems. The thermal management system can also include facilities for managing the heat transfer fluid, including, e.g., pumps, valves, fluid containment systems, pressure control systems, condensers, heat exchangers, heat sources, heat sinks, refrigeration systems, active temperature control systems, temperature and/or pressure sensors, flame sensors, carbon dioxide sensors, and passive temperature control systems.

The provided system can include a nonflammable, inert, nonaqueous thermal transfer medium. By nonflammable it is meant that the medium does not easily support combustion. By inert it is meant that under normal operating conditions of the system, the medium does not substantially react with the components of the system or the electronic device. For heat-transfer processing requiring an inert fluid, fluorocarbon or hydrofluorocarbons can be used. Fluorocarbon fluids typically have low toxicity, are essentially non-irritating to the skin, are non-chemically reactive, are non-flammable (e.g. do not show a flash point according to ASTM D-3278-96 e-1 “Flash Point of Liquids by Small Scale Closed-Cup Apparatus”), and have high dielectric strength may also be useful. Fluorocarbon fluids such as perfluorocarbons, hydrofluorocarbons, perfluoroketones, perfluoropolyethers, perfluoroethers, and hydrofluoroethers, can provide the additional advantage of not depleting the ozone layer in the stratosphere.

Ozone-depleting chemicals such as chlorofluorocarbons (CFCs) and hydrochlorofluorocarbons (HCFCs) have been phased out in developed countries under the 1987 Montreal Protocol. Alternative chemistries for refrigeration, aerosols, thermal management fluids, and other applications have been constrained by the inability to use bromine and chlorine, have included hydrofluorocarbons (HFCs) which have given good performance and have acceptable ozone-depleting properties. Recently, the global environmental community has turned its attention, with increasing urgency, to the issue of global warming. Under the 1997 Kyoto Protocol and the 2006 European Union F-gas regulation, materials with high global warming potential (GWP) need to be replaced by those that have a low global warming potential. Table 1 below (from P. Tuma, Proceedings, SEMI-THERM, March 2008, pp. 173-179) lists the global warming potentials (GWPs) of various thermal management fluids.

TABLE 1
Global Warming Potentials (GWPs) of Thermal Management Fluids

| Compound | Range of GWP |
|---|---|
| natural compounds | 1-300 |
| C6K | 1 |
| non flammable segregated | 50-375 |
| HFEs | |
| non-flammable HFCs | 1000-15,000 |
| HFCs | 125-15,000 |
| PFCs | 7,500-10,000 |

The global warming potential (GWP) is a measure of how much a given mass of greenhouse gas is estimated to contribute to global warming. It is a relative scale which compares the gas to be measured to that of the same mass of carbon dioxide (GWP=1). A GWP is calculated over a specific time interval. The factors that contribute to the GWP include the absorption of infrared radiation, the spectral location of the absorbing wavelengths, and the atmospheric lifetime of the species. The atmospheric lifetimes and a determination of the GWP of various compounds can be made as described in IPCC, 2007: Climate Change 2007: The Physical Science Basis. Contribution of Working Group 1 to the Fourth Assessment Report of the Intergovernmental Panel on Climate Change [Solomon, S., D. Qin, M. Manning, Z. Chen, M. Marquis, K. B. Averyt, M. Tignor and H. L. Miller (eds.)]. Cambridge University Press, Cambridge, United Kingdom and New York, N.Y., USA, 996 pp, 2007.

In the provided protection system and methods, it is desirable to use a thermal management fluid that has a low GWP. The GWP of the thermal management fluids should be about 1000 or less, about 100 or less, about 10 or less, or even about 1 or less.

In some embodiments the provided thermal management system includes a hydrofluoroether heat-management fluid (or a mixture of hydrofluoroether heat-transfer fluids) that is inert, has high dielectric strength, low electrical conductivity, chemical inertness, thermal stability and effective heat transfer. Additionally, the provided system comprises a heat-management fluid that is liquid, and has good heat transfer properties over a wide temperature range. Hydrofluoroethers are disclosed, for example, in U.S. Pat. Publ. No. 2006/012821 (Owens et al.). Exemplary hydrofluoroethers that can be useful in embodiments of the provided system include compounds represented by the following structure:

(R—O)ₓ—R′ (I)

wherein: x is 1 or 2; O is oxygen; one of R and R′ is a perfluoroaliphatic or perfluorocyclic group and the other is an aliphatic or a cyclic group. When x is 2 each R may comprise the same or a different number of carbon atoms. When R or R′ is a perfluoroaliphatic or perfluorocyclic group it may optionally contain one or more in chain heteroatoms such as O, N, or S atoms.

Other hydrofluoroether compounds useful in embodiments of the provided system include fluorinated ethers of the formula, R¹_{f—O—R}¹_{f}′, where R¹_{f} and R¹_{f}′ are the same or different and are selected from the group consisting of substituted and nonsubstituted alkyl, aryl, and alkylaryl groups and their derivatives. At least one of R¹_{f} and R¹_{f}′ contains at least one fluorine atom, and at least one of R¹_{f} and R¹_{f}′ contains at least one hydrogen atom. Optionally, one or both of R¹_{f} and R¹_{f}′ may contain one or more catenated or noncatenated heteroatoms, such as nitrogen, oxygen, or sulfur, and/or one or more halogen atoms, including chlorine, bromine, or iodine. R¹_{f} and R¹_{f}′ may also optionally contain one or more functional groups, including carbonyl, carboxyl, thiol, amino, amide, ester, ether, hydroxyl, and mercapto groups. R³_{f} and R³_{f}′ may also be linear, branched, or cyclic alkyl groups, and may contain one or more unsaturated carbon-carbon bonds. These materials are disclosed, for example, in
U.S. Pat. No. 5,713,211 (Sherwood).

Representative examples of hydrofluoroethers suitable for use in the processes and systems of the invention include the following compounds: C₅F₁₁OC₂H₅, C₃F₇OCH₃, C₄F₉OCH₃, C₄F₉OC₂H₅, C₃F₇OCF(CF₃)CF₂OCH₃, C₄F₉OC₂F₄OC₂F₄OC₂H₅, C₄F₉O(CF₂)₃OCH₃, C₃F₇CF(OC₂H₅)CF(CF₃)₂, C₂F₅CF(OCH₃)CF(CF₃)₂, C₄F₉OC₂H₄OC₄F₉,

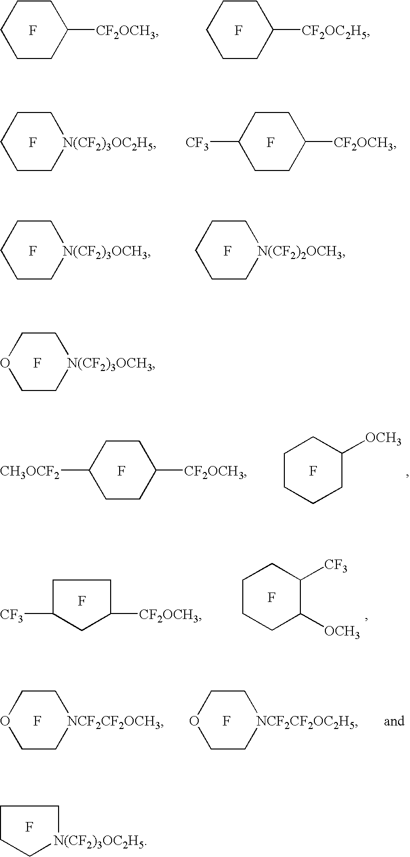

Other useful hydrofluoroether compounds are disclosed, for example, in U.S. Pat. No. 5,962,390 (Flynn et al.) U.S. Pat. Nos. 6,953,082; 7,055,579; and 7,128,133 (all Costello et al.). Other hydrofluoroether compounds useful in some embodiments of the provided system include cyclic hydrofluoroether compounds such as those disclosed in U.S. Pat. Publ. Nos. 2007/0267464 (Vitcak et al.). These compounds can be represented by the general formulas (II) and (III):

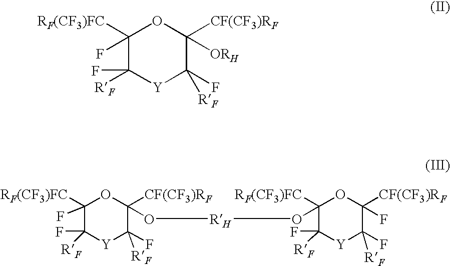

wherein each R_{F} is independently a linear or branched perfluoroalkyl group that optionally contains at least one catenated heteroatom selected from divalent ether oxygen atoms and trivalent nitrogen atoms and that optionally comprises a terminal moiety selected from —CF₂H, —CFHCF₃, and —CF₂OCH₃ (preferably, a linear or branched perfluoroalkyl group that has from one to about six carbon atoms and that optionally contains at least one catenated heteroatom selected from divalent ether oxygen atoms and trivalent nitrogen atoms; more preferably, a linear or branched perfluoroalkyl group that has from one to about three carbon atoms and that optionally contains at least one catenated divalent ether oxygen atom; most preferably, a perfluoromethyl group); each R_{F}′ is independently a fluorine atom or a perfluoroalkyl group that is linear or branched and that optionally contains at least one catenated heteroatom (preferably, having from one to about four carbon atoms and/or no catenated heteroatoms); Y is a covalent bond, —O—, —CF(R_{F})—, or —N(R_{F}″)—, wherein R_{F}″ is a perfluoroalkyl group that is linear or branched and that optionally contains at least one catenated heteroatom (preferably, having from one to about four carbon atoms and/or no catenated heteroatoms); R_{H}′ is an alkylene group that is linear, branched, cyclic, or a combination thereof, that has at least two carbon atoms, and that optionally contains at least one catenated heteroatom (preferably, linear or branched and/or having from two to about eight carbon atoms and/or having at least four hydrogen atoms and/or no catenated heteroatoms).

In other embodiments the thermal management system can include fluorochemical ketone compounds such as those disclosed in U.S. Pat. No. 7,385,089 (Costello et al.). These fluorochemical ketone compounds can be represented by the following general formula (IV):

R²_{f}′—C(═O)—[CF₂—O—(CF₂CF₂O)ₘ—(CF₂O)ₙ—CF₂]—C(═O)—R²_{f}″ (IV)

wherein R²_{f}′ and R²_{f}″ are each independently a branched perfluoroalkyl group that optionally contains at least one catenated heteroatom and that optionally comprises a terminal moiety selected from —CF₂H, —CFHCF₃, and —CF₂OCH₃; m is an integer of one to about 100; n is an integer of zero to about 100; and the tetrafluoroethyleneoxy (—CF₂CF₂O—) and difluoromethyleneoxy (—CF₂O—) moieties are randomly or non-randomly distributed. Preferably, R²_{f}′ and R²_{f}″ are each independently branched perfluoroalkyl groups that optionally contain at least one catenated heteroatom (more preferably, branched perfluoroalkyl groups having from about 3 to about 6 carbon atoms); m is an integer of one to about 25 (more preferably, one to about 15); and n is an integer of zero to about 25 (more preferably, zero to about 15).

Yet other heat management fluids that are useful in the provided systems include fluorinated or partially fluorinated ketones that are useful as fire extinguishing agents. Useful fluorinated ketones include ketones which are fully fluorinated, i.e., all of the hydrogen atoms in the carbon backbone have been replaced with fluorine; or ketones which are fully fluorinated except for one to three hydrogen, chlorine, bromine and/or iodine atoms remaining on the carbon backbone. Exemplary fluorinated ketones include CF₃CF₂C(O)CH₃. In some embodiments, the provided protection system includes 1,1,1,2,2,4,5,5,5-nonofluoro-4-trifluoromethyl-pentane-3-one (referred to as CF₃CF₂C(O)CF(CF₃)₂ or (C6K) elsewhere in this disclosure). The fluoroketones may also include those that contain one or more catenated heteroatoms interrupting the carbon backbone in the perfluorinated portion of the molecule. A catenated heteroatom is, for example, a nitrogen, oxygen or sulfur atom. Typically, the majority of halogen atoms attached to the carbon backbone are fluorine; most preferably, all of the halogen atoms are fluorine so that the ketone is a perfluorinated ketone. More preferred fluorinated ketones have a total of 4 to 8 carbon atoms. Representative examples of perfluorinated ketone compounds suitable for use in the processes and compositions of the invention include CF₃CF₂C(O)CF(CF₃)₂, (CF₃)₂CFC(O)CF(CF₃)₂, CF₃(CF₂)₂C(O)CF(CF₃)₂, CF₃(CF₂)₃C(O)CF(CF₃)₂, CF₃(CF₂)₅C(O)CF₃, CF₃CF₂C(O)CF₂CF₂CF₃, CF₃C(O)CF(CF₃)₂, and perfluorocyclohexanone. These compositions are disclosed, for example, in U.S. Pat. No. 6,478,979 (Rivers et al.).

In addition to demonstrating excellent fire-fighting performance, fluorinated ketones offer important benefits in environmental friendliness and can offer additional important benefits in toxicity. For example, CF₃CF₂C(O)CF(CF₃)₂ (C6K) has low acute toxicity, based on short term inhalation tests with mice exposed for four hours at a concentration of 50,000 ppm in air. Based on photolysis studies at 300 nm, CF₃CF₂C(O)CF(CF₃)₂ has an estimated atmospheric lifetime of 1 to 2 weeks (N. Taniguchi, et al., J. Phys. Chem., A 2003, 107, 2674-2679). Other fluorinated ketones show similar absorbencies and are expected to have similar atmospheric lifetimes. As a result of their rapid degradation in the lower atmosphere, the perfluorinated ketones have short atmospheric lifetimes and would not be expected to contribute significantly to global warming. A description of the properties and use of CF₃CF₂C(O)CF(CF₃)₂ as a heat transfer fluid for passive and pumped 2-phase applications is disclosed, for example, in P. Tuma, Proceedings, SEMI-THERM, March 2008, pp. 173-179.

Examples of thermal management fluids that are useful in the provided system and method include hydrofluoroethers and fluoroketones available, for example, under the trade designation NOVEC Engineered Fluids (available from 3M Company, St. Paul, Minn.) or VERTEL Specialty Fluids (available from DuPont, Wilmington, Del.). Particularly useful fluids include NOVEC 1230, NOVEC 7000, NOVEC 7100, NOVEC 7200, NOVEC 7300, NOVEC 7500, and NOVEC 7600, all available from 3M. Additionally, thermal management fluids include fluorosulfones. In some embodiments the fluids can be mixed to provide custom properties to the end user.

Other useful fluids include hydrofluorocarbons with low GWP. These fluids include for example C₄F₉C₂H₅ and C₆F₁₃C₂H₅. Additional useful fluids include fluoroolefins with low GWP. These fluids include for example CF₃CF═CH₂ and CF₃CF═CFCF(CF₃)₂.

The provided protection systems and methods include a valve in the thermal management system that is designed, in response to a stimulus, to cause at least a part of the thermal management fluid to be diverted from the thermal management system, through the valve, and onto the heat-generating electronic device. The stimulus can be, in some embodiments, a spark, fire, flame, smoke, or other incendiary event. The stimulus can come from the heat-generating electronic device itself or from another source close by. In such a case, it is contemplated that, in response to the stimulus, the thermal management fluid can be diverted from the thermal management system onto the other source which can be in the same enclosure, in an adjacent room or area, or anywhere that is close enough to allow the thermal management fluid to be diverted thereon. Typically, the thermal management fluids that are chosen are dielectric, able to transfer heat efficiently, and are fire extinguishing agents. The fluids that are chosen can act as both thermal management fluids (typically coolants) within the thermal management system and can act as fire extinguishers when they are diverted in response to a stimulus.

The provided protection systems can include a sensor. The sensor can detect the presence of an environmental condition that can pose a danger to the electronic device. For example, the sensor can detect heat, heating rate, humidity, ionization, light, noise, electrical current, or magnetic fields. The purpose of the sensor may be to detect a danger such as a flame, fire, spark, smoke, or other overheating condition that can stimulate the sensor and alert the system to a change in the environment of the electronic device. Such a stimulus can activate the sensor which can be in electronic communication with one or more valves. The valves, which are described below, can divert the thermal management fluid onto the electronic device. Examples of sensors that can be useful in the provided systems include smoke detectors, flame detectors, heat detectors, infrared detectors, and visible light detectors. It is also within the scope of this disclosure that a person, such as an operator, can be a sensor.

The thermal management system is typically a closed system. It can include at least two heat exchangers. When the thermal management system is used to cool the heat-generating electronic device heat can be transferred from the electronic device to the fluid, usually through a heat exchanger in contact with at least a part of the electronic device or the heat can be transferred to circulating air which can conduct the heat to a heat exchanger that is in thermal contact with the thermal management fluid. Alternatively, the fluid can contact the electronic device directly and so receive the thermal energy by contact. The fluid then, as a warmed fluid or as a vapor, can be circulated to a heat exchanger which takes the heat from the fluid and transfers it to the outside environment. After this heat transfer, the cooled thermal transfer fluid (cooled or condensed) is recycled. The thermal management system has a valve. The valve can be passive or active. A passive valve can include a material that ruptures in response to the stimulus. For example, passive valves such as sprinkler heads are known that have a material that melts at a preset temperature and allow a thermal management fluid, typically, water, to cool a fire that starts in a building. In the same manner, it is contemplated that the provided thermal management systems can have a part of the coolant conduit that ruptures in response to heat or flame allowing at least a part of the fluid to spray onto the “hot” electronic device and extinguish any flame that has been produced.

Alternatively, the valve can be active and can be triggered by a sensor. The sensor, which is described above, can send a signal to the valve to cause it to divert the recirculating fluid onto the heat-generating device. The signal can be an electronic, magnetic, or optical signal that can be conveyed through a wire, optical fiber, or magnetic bar, or alternatively, can be delivered in a wireless manner. An example of a wireless automated protection system can be found, for example, in European Pat. App. Publ. No. 1,845,499 A2 (Cool et al.). The valve can also be triggered manually by an operator that senses the stimulus.

The electronic devices can be in an enclosure. Enclosure can include integrated cabinets or groups of cabinets that can include racks or other means for supporting electronic equipment, heat management by liquid cooling, fire suppression systems, uninterruptable power supplies, power quality management, remote monitoring and control of cabinet parameters, such as temperature, humidity, intrusion, or sensor that respond to a stimulus. An exemplary enclosure for electronic devices is disclosed, for example, in U.S. Pat. Publ. No. 2004/0132398 A1 (Sharp et al.). An enclosure can include a room or a building that contains one or more electronic devices.

Important heat-generating electronic devices include datacenters. Currently datacenters consume about 2% of the electricity produced in the United States. It is expected that by the year 2011 the power consumption of datacenters will increase by more than 100%. Therefore, the energy efficiency and environmental impact of datacenters need to be considered when they are designed and operated. The provided protection system, which combines thermal management fluids with fire suppressants are designed to increase the energy efficiency of datacenters by providing needed thermal management systems and also address safety concerns from overheating. In addition, embodiments of the provided protection system use fluids with low global warming potentials. In some embodiments, the fluids have global warming potentials that are 10 or less.

In another aspect, a method of thermal management and fire protection of an electronic apparatus is provided that includes providing an electronic apparatus, thermally managing the electronic apparatus with a thermal management system comprising at least one recirculating thermal management fluid, sensing a flame in or near the electronic apparatus, opening a valve in the thermal management system in response to sensing a flame in or near the electronic apparatus, diverting thermal management fluid from the thermal management system by the valve onto the electronic apparatus, and extinguishing the flame, wherein the thermal management fluid includes a fire extinguishing agent. The electronic device and the thermal management system are described above as are all of the other features of the provided method. The electronic device can include a datacenter. The thermal management fluid can have a global warming potential of less than about 10 and can comprise a fluorocarbon which can be a perfluoroketone. A typical perfluoroketone is CF₃CF₂C(O)CF(CF₃)₂.

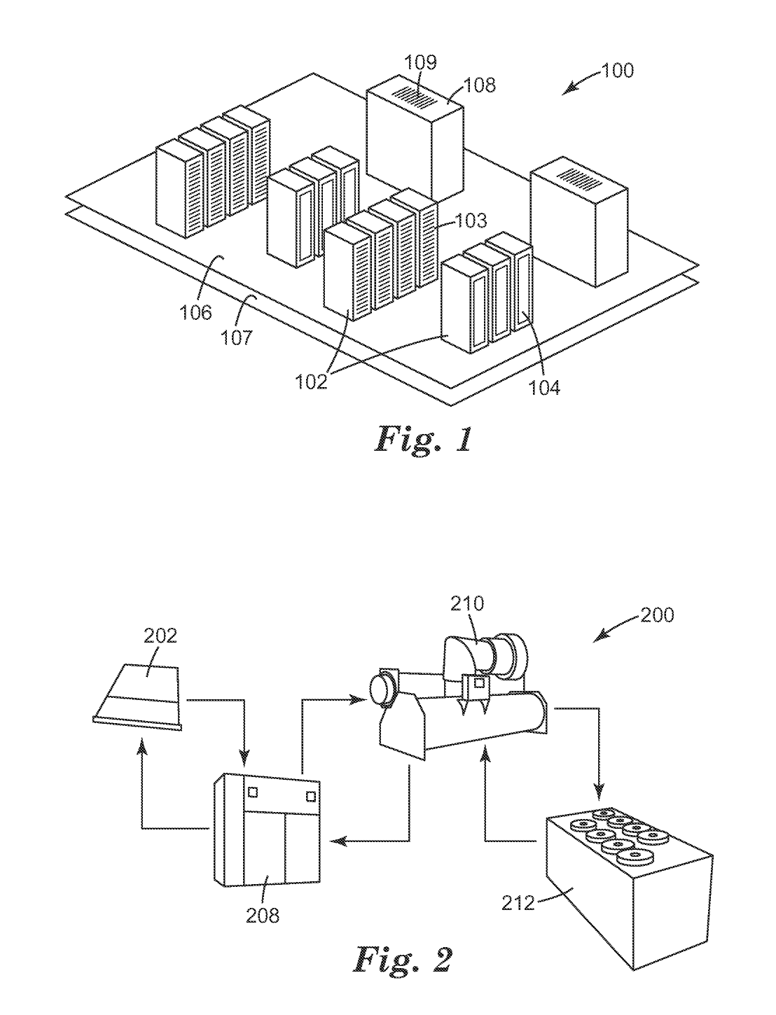

FIG. 1 shows a typical air-cooled datacenter layout. Datacenter 100 includes a plurality of server cabinets or racks 102. Each cabinet 102 has an air intake side 103 to take in cool air to cool the servers inside and an air exhaust side 104 to emit air that has taken heat away from the servers inside of the cabinet. Datacenter 100 in enclosed in a room. The plurality of server cabinets are alternatively positioned in rows so that the air intakes sides of each cabinet face an aisle that circulates cooler air and the air exhaust sides of each cabinet face an aisle that circulates warmer air. Floor 106 is raised has perforated tiles in the air intake aisles so that cooler air can flow under raised floor 106 can come up through the perforated tiles in the aisles with cooler air and go through the air intakes 103 of the server cabinets. The warmer air from the server cabinets is emitted from the air exhaust sides 104 of the cabinets and rises to the ceiling. Computer room air conditioner units 108 are located near the server cabinets and can intake warm air through intake 109 on top of the units and can recirculated cool air beneath the floor.

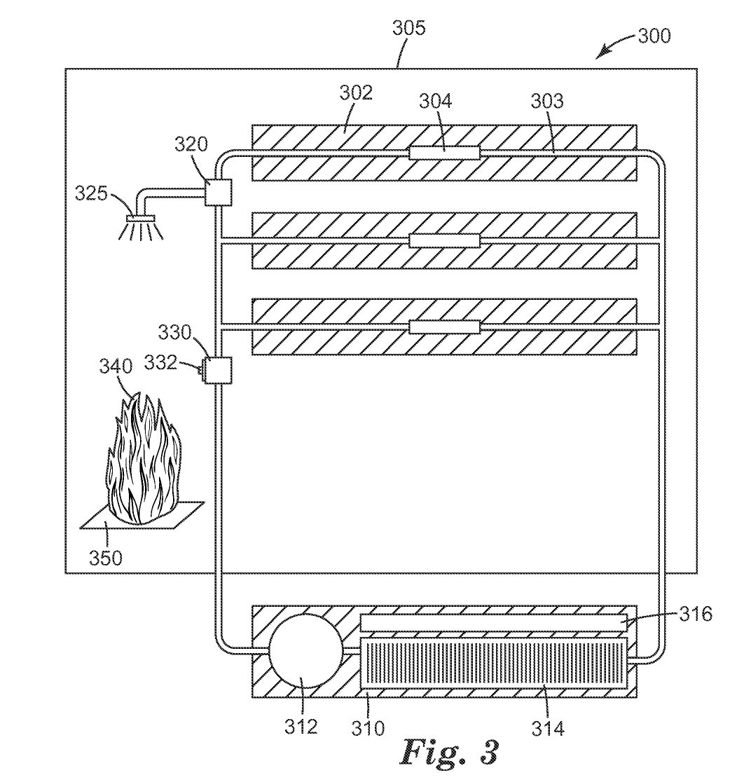

FIG. 2 illustrates a typical heat transfer path in a typical state-of-the-art air-cooled datacenter such as that shown in FIG. 1. Heat transfer path 200 takes heat from server 202 which can also be a rack of servers and circulates the heat to computer room air conditioner 208 which is part of a datacenter and is housed in an enclosed room such as is illustrated in FIG. 1. Computer room air conditioner 208 transfers heat to a heat transfer fluid (typically facility water) which is circulated to a chiller 210 and then back to the air conditioner after the heat transfer. Finally, chiller 210 transfers heat through another heat transfer fluid to cooling tower 212 that can be located outside of the building that contains the datacenter. Alternatively, computer room air conditioner 208 transfers heat via a heat transfer fluid directly to cooling tower 212.

FIG. 3 illustrates an embodiment of the provided protection system. The protection system 300 includes a plurality of servers 302 in a datacenter that have a thermal management (cooling) fluid circulating through conduits 303 to heat exchanging elements 304 that are in thermal contact with the server components. The fluid is circulated through conduits 303 to thermal management unit 310. Thermal management unit 310 includes pump 312 that circulates the fluid through heat exchanger 314 which is in thermal contact with fan 316. The cooler fluid is then recirculated back through the servers. Conduits 303 are a closed fluid system and contain at least one valve. In FIG. 3 two valves are shown for illustrative purposes—one active and one passive. Active valve 320 is can be electronically opened in response to a stimulus such as flame 340. When it is opened, thermal transfer fluid can be diverted from conduit 303 through a distribution element such as sprinkler head 325 and onto an electronic device 350 that is enflamed. Electronic device 350 can be located within enclosure 305 that encloses servers 302, heat exchanging elements 304, and conduits 303. In the illustrated embodiment, thermal management unit 310, pump 312, heat exchanger 314, and cooling fan 316 are located outside of enclosure 305. With the proper configuration of the conduit and valve system it is contemplated that the electronic device can be one of the servers 302 through which the thermal management system circulates or it can be another part of the datacenter. The fluid can extinguish the flame. Alternatively, the system can contain passive valve 330. Passive valve 330 can have a temperature sensitive material 332 that can melt or otherwise change its physical properties in response to a flame or heat such as that from flame 340. When the material 332 melts, for example, fluid can be diverted from conduit 303 through a distribution element such as a sprinkler heat and onto electronic device 350 that is enflamed.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

What is claimed is:

1. A protection system comprising:
a heat-generating electronic device;
a thermal management system comprising at least one recirculating thermal management fluid, the thermal management system designed so as to transfer heat from the heat-generating electronic device, and
a valve in the thermal management system designed to cause at least a part of the thermal management fluid to be diverted from the thermal management system through the valve and onto the heat-generating electronic device or a flame nearby in response to a stimulus,
wherein the thermal management fluid comprises a fire extinguishing agent.

2. A protection system according to claim 1, wherein the heat-generating electronic device comprises a datacenter comprising an electronic component.

3. A protection system according to claim 2 wherein the electronic component comprises a power electronic device, an electrochemical cell, or a server.

4. A protection system according to claim 1, wherein the electronic device is enclosed.

5. A protection system according to claim 4, wherein the thermal management system cools air within the enclosed electronic device.

6. A protection system according to claim 1, wherein the thermal management system cools air that is in contact with the electronic device.

7. A protection system according to claim 1, wherein thermal management system is in direct contact with at least a portion of the electronic device.

8. A protection system according to claim 1, wherein the thermal management fluid has a global warming potential of less than about 10.

9. A protection system according to claim 1, wherein the thermal management fluid comprises a fluorocarbon.

10. A protection system according to claim 9, wherein the fluorocarbon comprises a perfluoroketone.

11. A protection system according to claim 10, wherein the perfluoroketone comprises

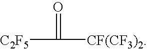

12. A protection system according to claim 1, further comprising a sensor.

13. A protection system according to claim 12, wherein the stimulus activates the sensor.

14. A protection system according to claim 13, wherein the sensor is in electronic communication with the valve.

15. A protection system according to claim 1 wherein the stimulus is detection of a flame.

16. A method of thermal management and fire protection of an electronic apparatus comprising:
providing an electronic device;
thermally managing the electronic device with a thermal management system comprising at least one recirculating thermal management fluid;
sensing a flame in or near the electronic device;
opening a valve in the thermal management system in response to sensing a flame in or near the electronic device;
diverting thermal management fluid from the thermal management system by the valve onto the electronic device or a flame nearby; and
extinguishing the flame,
wherein the thermal management fluid comprises a fire extinguishing agent.

17. A method of thermal management and protecting an electronic device according to claim 16, wherein the electronic apparatus comprises a datacenter.

18. A method of thermal management and protecting a datacenter according to claim 17, wherein the thermal management system comprises a thermal management fluid having a global warming potential of less than about 10.

19. A method of thermal management and protecting a datacenter according to claim 18, wherein the thermal management fluid comprises a fluorocarbon.

20. A method of thermal management and protecting a datacenter according to claim 19, wherein the fluorocarbon comprises a perfluoroketone.

21. A method of thermal management and protecting a datacenter according to claim 20, wherein the perfluoroketone comprises [chemical structure]
